(19) United States
(12) Patent Application Publication
(10) Pub. No.: US 2026/0289770 A1
(43) Pub. Date: Sep. 24, 2026

(54) BIRD FLOCK HEALTH

(71) Applicant: SIGNIFY HOLDING B.V., EINDHOVEN (NL)

(72) Inventors: JAEHAN KOH, CHESTNUT HILL, MA (US); MATHAN KUMAR GOPALSAMY, MEDFORD, MA (US); PETER DEIXLER, ARLINGTON, MA (US); JEFFREY JOSEPH RODNY, WOBURN, MA (US); DEEPAK THIPPESWAMY, WESTFORD, MA (US)

(21) Appl. No.: 19/476,216

(22) PCT Filed: Apr. 11, 2024
(86) PCT No.: PCT/EP2024/059860

§ 371 Date: Oct. 17, 2025

Related U.S. Application Data
(60) Provisional application No. 63/460,633, filed on Apr. 20, 2023.

(30) Foreign Application Priority Data
May 4, 2023 (EP) 23171615.0

(51) Int. Cl. G06T 7/00; A01K 45/00; G06T 7/70; G06V 10/141; G06V 10/25; G06V 10/60; G06V 10/82; G06V 20/52; G06V 40/10

(52) U.S. Cl. CPC G06T 7/0012; A01K 45/00; G06T 7/70; G06V 10/141; G06V 10/25; G06V 10/60; G06V 20/52; G06V 40/10; G06T 2207/20084; G06T 2207/30188; G06T 2207/30232; G06V 10/82

(57) ABSTRACT

System and method are disclosed for poultry monitoring and disease detection in one or more poultry accommodated in a shed. Real-time images of the shed are collected through image acquisition units 104 installed at the shed, and using a recurrent neural network (RNN) architecture such as long short-term memory (LSTM) the received images are analysed, that facilitates in determining diseases such as flu, Newcastle disease, avian influenza, and etc. in the each of the accommodated poultry to classify healthy and unhealthy poultry. An automated arm 106 is provided to pick the unhealthy poultry form a first pre-defined area of the shed to the second pre-defined area of the shed. In addition, concerned authorities may be notified regarding the disease in poultry, thus further action may be taken to prevent infection in healthy poultry stored in the shed.

### TECHNICAL FIELD

The present disclosure relates in general to system for monitoring poultry, and more particularly to a system for monitoring poultry and detecting unhealthy poultry to reduce infection form unhealthy poultry to healthy poultry.

### BACKGROUND

Background description includes information that may be useful in understanding the present invention. It is not an admission that any of the information provided herein is prior art or relevant to the presently claimed invention, or that any publication specifically or implicitly referenced is prior art.

In general, animals raised in sheds are wild animals that have been domesticated and improved by humans and are useful for human life to provide livestock products and labor. The animals raised in sheds include birds such as poultry and livestock which narrowly refer only to such mammals. The poultry includes chickens, ducks, and the like, and the livestock include pigs, cattle, cows, horses, goats, and the like.

As industries develop, the livestock industry is also developing. According to the development of the livestock industry, massive numbers of poultry and livestock are being raised in sheds.

However, as described above, when massive numbers of poultry are raised in sheds, if an infectious disease such as Newcastle disease, avian influenza occurs, poultry raised in the sheds are killed at the same time, which results in serious financial losses for poultry farms.

In order to address the above problem, poultry farmers manually check fever or abnormal symptoms of poultry trapped in the shed in the related art. Such work wastefully consumes time and requires excessive human resources.

As a result, there is an urgent necessity to use advanced strategies in poultry disease management, identify diseases early on, and respond quickly in such management.

Therefore, to overcome the above mentioned drawback, there is need to develop a system to detect unhealthy poultry in the sheds, and separating the unhealthy poultry to reduce chances of infection.

### OBJECTS OF THE PRESENT DISCLOSURE

Some of the objects of the present disclosure, which at least one embodiment herein satisfies are as listed herein below.

An object of the present disclosure is to provide an automatic poultry monitoring system.

It is another object of the present disclosure to detect diseases such as flu, Newcastle disease, Avian Influenza in poultry accommodated in a shed.

It is another object of the present disclosure to prevent infection of diseases in the shed, by separating unhealthy poultry.

It is another object of the present disclosure to notify owner of the shed, upon detection of disease in any of the poultry in the shed.

Other object, features, and advantages will become apparent from detail description and appended claims to those skilled in the art.

### SUMMARY

Various aspects of the present disclosure relates to system for monitoring poultry. In particular the present disclosure relates to a system for monitoring poultry and detecting unhealthy poultry to reduce infection form unhealthy poultry to healthy poultry

According to an aspect of the present disclosure a system for poultry monitoring may include an electronic tag positioned to each poultry accommodated in a first pre-defined area, one or more image acquisition units may be positioned at the first pre-defined area to acquire one or more images of the first-pre-defined area, an automated arm may be coupled in the first pre-defined area to move unhealthy one or more poultry from the first pre-defined area to a second pre-defined area, a processing unit may be operatively coupled to each of the one or more image acquisition units, and the robot automated arm.

In an aspect, the processing unit may include a learning engine coupled with a memory, the memory storing instructions executable by the learning engine and configured to extract one or more poultry from the received images, in the first pre-defined area, extract one or more characteristics of each of the poultry detected in the first pre-defined area using the learning engine, analyse the extracted one or more characteristics of each of the poultry to detect unhealthy poultry, and may generate an activation signal to activate the automated arm, wherein the activation signal pertains information of the electronic tag of the unhealthy one or more poultry detected in the first-predefined area, and upon activation, the automated arm pick at least one of the unhealthy poultry from the first pre-defined area and drop into the second-predefined area.

In an aspect, the electronic tag may include any or a combination of Radio Frequency Identification (RFID) tag, and Ultra Wide-Band (UWB) tag.

In an aspect, the automated arm may include a tag reader to identify each of the poultry, and upon receiving the activation signal from the processing unit, the tag reader activates and identify the unhealthy one or more poultry in the first-predefined area in accordance with the electronic tag.

In an aspect, a front end of the automated arm may be designed in such a manner that facilitates in holding the one or more poultry.

In an aspect, the learning engine may include an artificial recurrent neural network (RNN) architecture.

In an aspect, the artificial recurrent neural network (RNN) architecture may include a long short-term memory (LSTM) architecture.

In an aspect, the one or more characteristics of each of the poultry may include any or a combination of physical damage, behaviour, and physiological state.

In an aspect, the processing unit may be further configured to transmit a notification signal to one or more mobile computing devices via a communication unit, upon detection of one or more unhealthy poultry in the first pre-defined area.

Another aspect of the present disclosure pertains to a method for monitoring poultry and separating unhealthy poultry, the method may include receiving, at a processing unit, one or more images of a first-predefined area, processing, by the processing unit, the received one or more images to detect unhealthy one or more poultry in the first pre-defined area, by analysing one or more characteristics of each of the poultry found in the first-predefined area, activating, by the processing unit, an automated arm to move the unhealthy one or more poultry from the first pre-defined area to a second-predefined area, verifying, the unhealthy one or more poultry by scanning the electronic tag positioned on each of the poultry, from a tag reader positioned on the automated arm, and moving, by the automated arm, the unhealthy one or more poultry from the first-predefined area to the second pre-defined area.

Various objects, features, aspects and advantages of the inventive subject matter will become more apparent from the following detailed description of preferred embodiments, along with the accompanying drawing figures in which like numerals represent like components.

### BRIEF DESCRIPTION OF DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

FIG. 1 illustrates an exemplary block diagram of a poultry monitoring system, in accordance with an embodiment of the present disclosure.

FIG. 2 illustrates an exemplary functional components of a processing unit of the proposed system, in accordance with an embodiment of the present disclosure.

FIG. 3 illustrates an exemplary method for monitoring and separating unhealthy poultry, in accordance with an embodiment of the present disclosure.

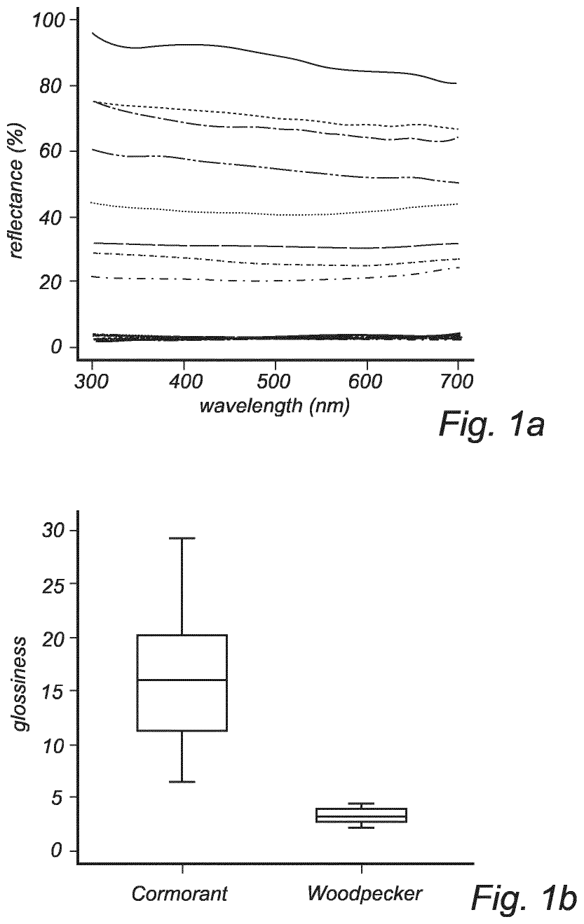

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details. Embodiments explained herein relate to system for monitoring poultry. In particular the present disclosure relates to a system for monitoring poultry and detecting unhealthy poultry to reduce infection form unhealthy poultry to healthy poultry.

The term “poultry” as used herein the description are used to indicate a plurality of poultry.

According to an embodiment of the present disclosure, a poultry monitoring system 100 (also referred as system 100, hereinafter) for detecting disease in one or more poultry (interchangeably referred as poultry, hereinafter) and separation of healthy and unhealthy poultry are disclosed. The poultry can include chickens (including bantams), turkeys, ducks, geese, partridges, quail, pheasants, pigeons-reared for meat, guinea fowl, ostriches, emus and rheas. The system 100 can be installed in a shed accommodating poultry, the shed can be divided into two areas, a first pre-defined area and a second-predefined area. The system 100 can include an electronic tag 102 positioned to each poultry accommodated in a first pre-defined area, the electronic tag can include such as but not limited to, Radio Frequency Identification (RFID) tag, and Ultra Wide-Band (UWB) tag. The electronic tag can be configured to detect each poultry individually.

In an embodiment, the electronic tag can be attached to each of the poultry such as, for non-limiting example, as an ear tag or a nose ring, or can be worn on the each of the poultry, for example, as part of or attached to a collar, halter, harness or belly band. The identification means can be implanted in the poultry.

In an embodiment, the system 100 can include one or more image acquisition units 104 (collectively referred as image acquisition units 104, and individually referred as image acquisition unit 104) positioned at the first pre-defined area to acquire one or more images (also referred as images, hereinafter) of the first-pre-defined area. Each of the image acquisition unit 104 can include but not limited to, a camera, a complementary metal-oxide semiconductor (CMOS) module, a charge coupled device (CCD) module, webcam and surveillance that can be installed on various positions on the shed.

In an embodiment, an automated arm 106 can be positioned in the shed that can include a front end designed in such a manner that enable the automated arm to pick the poultry easily. The automated arm 106 can be configured to separate the unhealthy poultry from the heathy poultry by picking the unhealthy poultry from the first pre-defined area and dropping to the second pre-defined area. A tag reader 114 can be coupled to the automated arm 106, and the tag reader 114 can be configured to identify each of the poultry in the shed, and upon receiving the activation signal from the processing unit 108, the tag reader 114 can be activated to identify the unhealthy poultry in the first-predefined area in accordance with the electronic tag 102.

In an embodiment, the image acquisition units 104 can be configured for acquiring one or more images or live streaming (i.e. videos) of the shed that can be transmitted to the processing unit 108 for analysis. The processing unit 108 can include a learning engine 110 coupled with a memory, the memory storing instructions executable by the learning engine and configured to analyse the images or videos of shed acquired by the image acquisition units 104. The learning engine 110 can be an artificial recurrent neural network (RNN) architecture, including long short-term memory (LSTM) architecture that can facilitates in analysing the received images or videos of the shed.

In an embodiment, the processing unit 108 can be configured to extract one or more poultry from the received images, in the first pre-defined area, extract one or more characteristics of each of the poultry detected in the first pre-defined area using the learning engine 110. The one or more characteristics can include such as but not limited to physical damage (wounds and bone breakage), behaviour (displacement preening, stereotyped behaviour, feather pecking and cannibalism, aggression, and fear), and physiological state (stress). The processing unit 108 can be further configured to analyse the extracted one or more characteristics of each of the poultry to detect unhealthy poultry (i.e. the poultry having flu, Newcastle disease, Avian Influenza, and the likes), and generate an activation signal to activate the automated arm 110. The activation signal can pertain information of the electronic tag of the unhealthy one or more poultry detected in the first-predefined area.

In an embodiment, upon receiving the activation signal, the automated arm 106 can be activated to pick at least one of the unhealthy poultry from the first pre-defined area and drop into the second-predefined area.

In an embodiment, the processing unit 108 can be further configured to transmit a notification signal to one or more mobile computing devices via a communication unit 112, upon detection of one or more unhealthy poultry in the first pre-defined area. The one or more mobile computing devices can be a desktop computer, a vehicle computer, a tablet computer, a personal digital assistant, a laptop, a navigational device, a portable media device, and a smart phone.

In an embodiment, the communication unit 112 can be configured to facilitate wireless Internet technology. Examples of such wireless Internet technology include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like.

In addition, the communication unit 112 can be configured to facilitate short-range communication. For example, short-range communication can be supported using at least one of Bluetooth, Radio Frequency Identification (RFID), Infrared Data Association (IrDA), Ultra-Wideband (UWB), ZigBee, Near Field Communication (NFC), Wireless-Fidelity (Wi-Fi), Wi-Fi Direct, Wireless USB (Wireless Universal Serial Bus), and the like.

In an embodiment, a power supply unit (not illustrated) can be configured to supply power required to operate the respective components under the control of the processing unit 110. In particular, the power supply unit for example, a battery, can receive external power and internal power under control of the processing unit 110 and can supply power necessary for operations of each component.

In an exemplary embodiment, the disease occurrence alarm (i.e. notification signal) can be transmitted to a server or a terminal of a related organization such as a disaster management division of a ministry of agriculture, food and rural affairs of a local government, a terminal of a shed owner, and the likes.

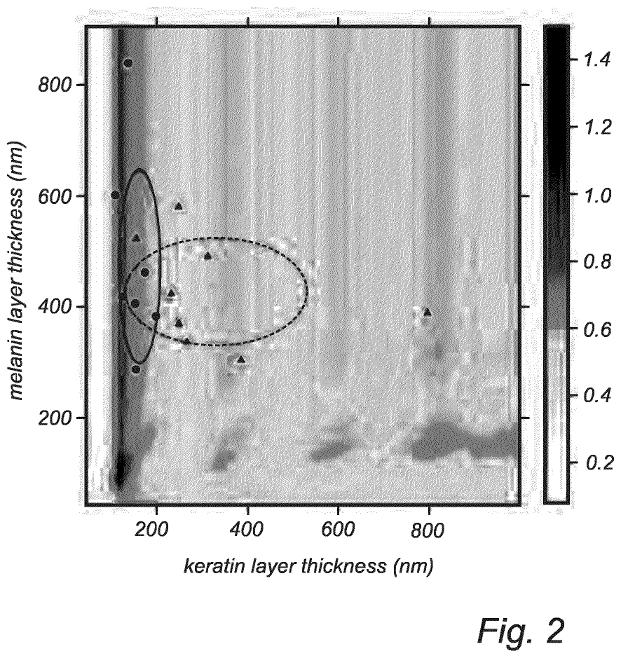

As illustrated in FIG. 2, a processing unit 108 can include one or more processor(s) 202. The one or more processor(s) 202 can be implemented as one or more microprocessors, microcomputers, microcontrollers, digital signal processors, central processing units, logic circuitries, and/or any devices that manipulate data based on operational instructions. Among other capabilities, the one or more processor(s) 202 can be configured to fetch and execute computer readable instructions stored in a memory 204 of the processing unit 108. The memory 204 can store one or more computer-readable instructions or routines, which may be fetched and executed to create or share the data units over a network service. The memory 204 can include any non-transitory storage device including, for example, volatile memory such as RAM, or non-volatile memory such as EPROM, flash memory, and the likes.

In an embodiment, the processing unit 108 can also include an interface(s) 206. The interface(s) 206 may comprise a variety of interfaces, for example, interfaces for data input and output devices, referred to as I/O devices, storage devices, and the like. The interface(s) 206 may facilitate communication of system 100. The interface(s) 206 may also provide a communication pathway for one or more components of the system 100. Examples of such components include, but are not limited to, learning engine(s) 110 and database 208.

In an embodiment, the learning engine(s) 110 can be implemented as a combination of hardware and programming (for example, programmable instructions) to implement one or more functionalities of the learning engine(s) 110. In examples described herein, such combinations of hardware and programming may be implemented in several different ways. For example, the programming for the learning engine(s) 110 may be processor executable instructions stored on a non-transitory machine-readable storage medium and the hardware for the learning engine(s) 110 may include a processing resource (for example, one or more processors), to execute such instructions. In the present examples, the machine-readable storage medium may store instructions that, when executed by the processing resource, implement the learning engine(s) 110. In such examples, the processing unit 108 can include the machine-readable storage medium storing the instructions and the processing resource to execute the instructions, or the machine-readable storage medium may be separate but accessible to processing unit 108 and the processing resource. In other examples, the learning engine(s) 110 may be implemented by electronic circuitry. The database 208 can include data that is either stored or generated as a result of functionalities implemented by any of the components of the learning engine(s) 110. In an embodiment, the learning engine(s) 110 can include a poultry detection unit 210, a feature extraction unit 212, a classification and training unit 214, a matching unit 216, a signal generation unit 218, and other unit(s) 220. The other unit(s) 220 can implement functionalities that supplement applications or functions performed by the system 100 or the learning engine(s) 110.

In an embodiment, the database 208 can include data that is either stored or generated as a result of functionalities implemented by any of the components of the learning engine(s) 110. The database 208 can be a server including several local and/or remote servers

It would be appreciated that units being described are only exemplary units and any other unit or sub-unit may be included as part of the system 100. These units too may be merged or divided into super-units or sub-units as may be configured.

In an embodiment, the learning engine 110 can include but not limited to an artificial recurrent neural network (RNN) architecture, long short-term memory (LSTM) architecture, machine learning algorithms and deep learning algorithms

In an exemplary embodiment, the learning engine 110 can include a convolutional neural network (CNN) and a long short-term memory recurrent neural network (LSTM-RNN). In general, the CNN can identify and extracts spatial features through an iterative process of convolving the images, pooling results of the convolving, and then repeating the process of convolving and pooling using the pooled results from a previous iteration. CNN can be implemented in this manner until a final fully connected layer outputs a feature map or other general indication of spatial features of the images after, for example, several iterations (e.g., 5 iterations of the CNN) the spatial information is used from the CNN as an electronic input into the LSTM. In general, the LSTM is a type of recurrent neural network that can determine temporal relationships or other temporal information about the spatial features identified by the CNN. That is, the LSTM-RNN can include aspects that account for changes between the images in order to identify health and unhealthy poultry. In either case, the learning engine 110 can implement the LSTM-RNN to produce a prediction of unhealthy and healthy poultry and can use the prediction to generate an output that can identify the particular states as statistical likelihoods or probabilities.

In an embodiment, the processing unit 104 can be configured to receive one or more images acquired by image acquisition units 104 in an electric form. The poultry detection unit 210 can be configured to detect poultry in a first pre-defined area form the received images, and the extracted information can be transmitted to the feature extraction unit 212.

In an embodiment, the feature extraction unit 212 can be configured to extract characteristics such as, but not limited to physical damage, behaviour, and physiological state, and the extracted characteristics can be matched using the matching unit 216 with a pre-defined dataset to determine one or more diseases such as but not limited to the likes flu, Newcastle disease, and Avian Influenza in the poultry.

In an embodiment, the extracted information (i.e. characteristics, and diseases) can be transmitted to the classification and training unit 214 in machine readable form or binary form, where the classification and training unit 214 can classify the information and correspondingly the signal generation unit 218 can generate activation signals, which can be transmitted to an automated arm. Upon receiving the activation signal, the automated arm 106 can read the electronic tag from a tag reader 114 to verify the unhealthy poultry, and pick the poultry from a front end of the automated arm 106 from a first pre-defined area of the shed, and move to the second pre-defined area of the shed.

In an embodiment, the classification and training unit 214 can be further configured to update and train the classification and training unit 214 based on the extracted and analysed information. A learning model can be trained based on the received and analysed information where the leaning model can be stored in the database 208.

In an embodiment, the signal generation unit 316 can be further configured to generate and transmit a notification signal that can be transmitted to one or more mobile computing devices via a communication unit 112 (such as Wi-Fi) to notify the owner regarding the unhealthy poultry, and the owner can take precautions accordingly. The one or more mobile computing devices can be a desktop computer, a vehicle computer, a tablet computer, a personal digital assistant, a laptop, a navigational device, a portable media device, and a smart phone.

In an embodiment of the proposed invention, conditions of the sheds can be understood in real time based on real time image information obtained by the image acquisition units 104 installed in the sheds, situations in which the infectious disease may occur are predicted and recognized, and information can be provided to shed owner/manager and related organizations such as officials of a ministry of agriculture, food and rural affairs, national centres for disease control and prevention, and a ministry of environment. Accordingly, it is possible to ultimately decrease national financial losses and damages of farms.

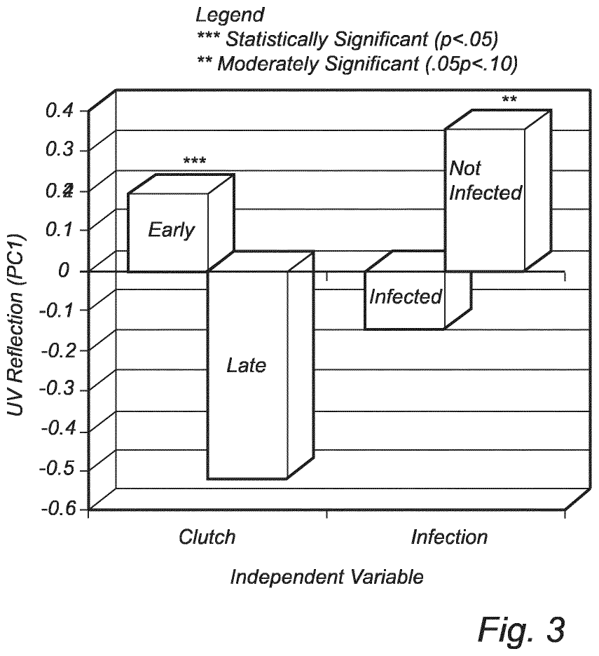

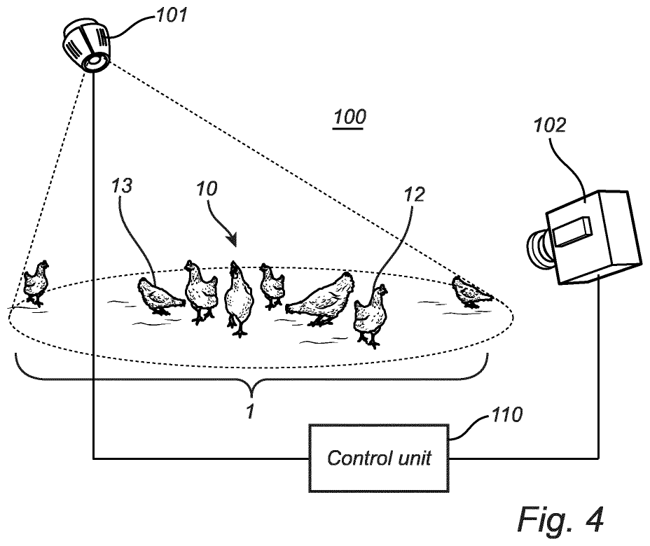

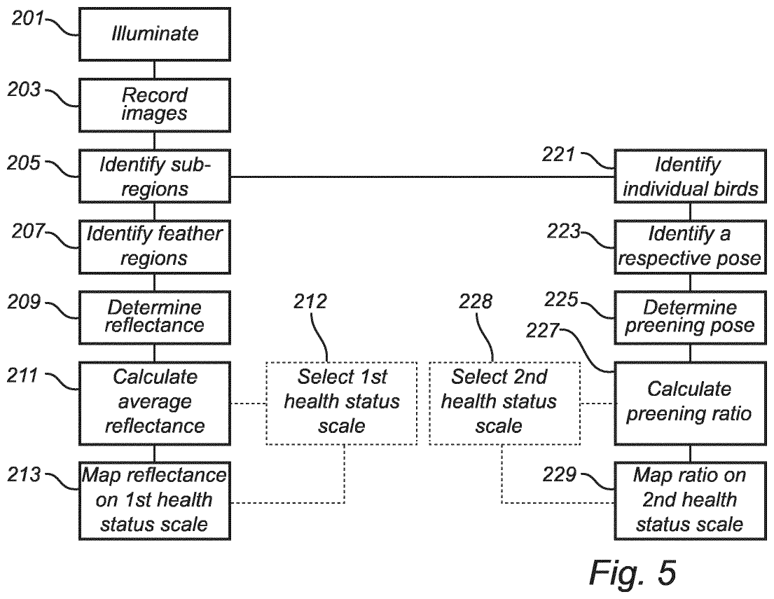

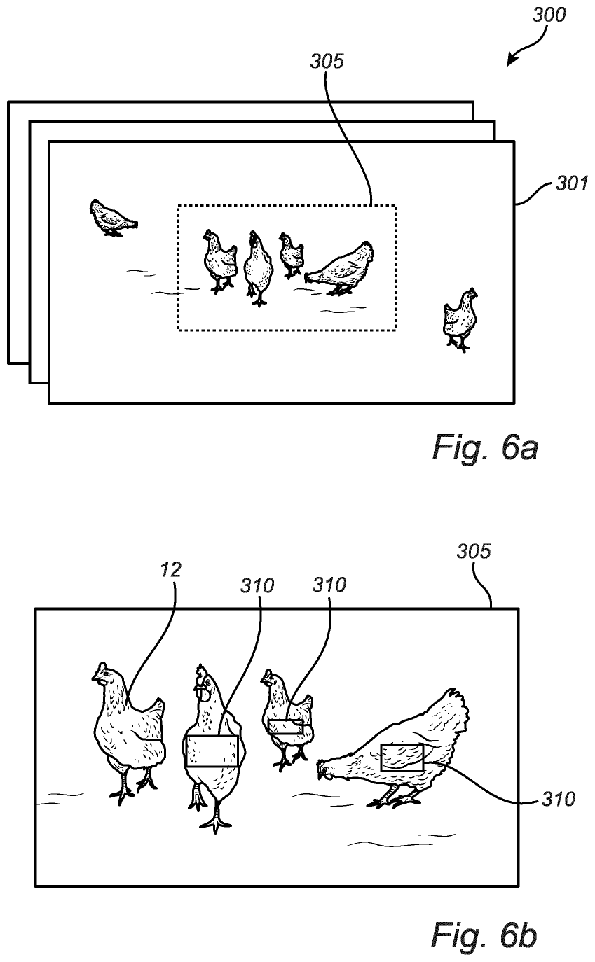

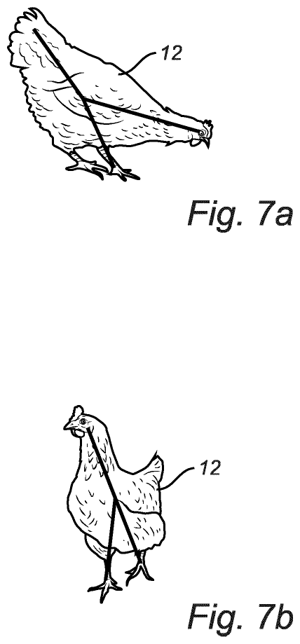

As illustrated in FIG. 3, a method 300 for monitoring and separating unhealthy poultry is disclosed. At step 302 the method 300 can include receiving at a processing unit 108 one or more images acquired by one or more image acquisition units 104. The image acquisition units 104 can be positioned on various location in a shed to acquire images of the entire shed.

At step 304, the method 300 can include processing of the received one or more images by the processing unit 108, to detect unhealthy one or more poultry in a first pre-defined area of the shed. The unhealthy poultry can be detected by analysing one or more characteristics of each of the poultry found in the first pre-defined area of the shed. The processing unit 108 can include a learning engine 110 having an artificial recurrent neural network (RNN) architecture, where the artificial recurrent neural network (RNN) architecture is a long short-term memory (LSTM) architecture that facilitates in accurately analysing the characteristics of each of the poultry detected in the images to detect diseases such as flu, Newcastle disease, Avian Influenza, and etc. in the poultry.

At step 306, the method 300 can include activating an automated arm by transmitting an activation signal from the processing unit. Upon activation, the automated arm move the unhealthy poultry from the first pre-defined area to a second-predefined area of the shed.

At step 308, the method 300 can include verifying, each of the unhealthy poultry by scanning the electronic tag positioned on each of the poultry, from a tag reader 114 positioned on the automated arm.

At step 310, the method 300 can include moving detected unhealthy poultry from the first-predefined area to the second pre-defined area by the automated arm.

In an embodiment, separation of the unhealthy one or more poultry from the first pre-defined area can reduce infection in other healthy poultry and prevent economic loss to owner of the shed. Also, a communicating unit 112 can transmit a notification signal to an infectious disease-related organization such as owner of the shed, a disaster management division of a ministry of agriculture, food and rural affairs of a local government or the shed.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The proposed invention provides an automatic poultry monitoring system.

The proposed invention provides a system to detect diseases such as flu, Newcastle disease, Avian Influenza in poultry accommodated in a shed.

The proposed invention provides a system to prevent infection of diseases in the shed, by separating unhealthy poultry.

The proposed invention provides a system to notify owner of the shed, upon detection of disease in any of the poultry in the shed.

1. A method of determining a health status for a flock of birds, the method comprising:
recording a plurality of images of an area,
identifying, in each image of the plurality of images, a respective image sub-region within which the flock of birds is present,
identifying, in each image sub-region, at least one feather image region within which feathers are present,
determining, for each feather image region a respective reflectance value sample,
calculating an average reflectance value based on the reflectance value samples, and
mapping the average reflectance value on a first health status scale, thereby obtaining a first health status value for the flock of birds.

2. The method of claim 1, wherein the step of determining, for each feather image region, a respective reflectance value sample comprises determining, for each feather image region, a respective diffuse reflectance value sample.

3. The method of claim 1, wherein the step of determining, for each feather image region a respective reflectance value sample comprises determining, for each feather image region, a respective specular reflectance value sample.

4. The method of claim 3, wherein the determining of a respective specular reflectance value sample comprises determining a respective specular reflectance value sample for a plurality of wavelength intervals and calculating a weighted average of the determined specular reflectance value samples.

5. The method of claim 4, wherein the determining of a respective specular reflectance value sample for a plurality of wavelength intervals comprises determining a respective specular reflectance value sample for an ultra violet, UV, wavelength interval.

6. The method of claim 1, further comprising:
selecting the first health status scale from a plurality of health status scales, each of which is representative of a respective type or species of birds.

7. The method of claim 1, wherein the first health status scale comprises two status values representing healthy and non-healthy, respectively, and wherein the step of mapping comprises:
normalizing the average reflectance value to a normalized average reflectance value,
mapping the normalized average reflectance value on the first health status scale and thereby obtaining a status value representing non-healthy if the normalized average reflectance value is between 0 and a threshold value and obtaining a status value representing healthy if the normalized average reflectance value is between the threshold value and 1.

8. The method of claim 1, further comprising:
identifying, in each image sub-region, a plurality of individual birds,
identifying, for each identified bird a respective pose,
determining, for each identified pose, whether or not the pose is a preening pose,
calculating, based on the determined poses, a ratio between the number of poses determined to be a preening pose and the number of poses determined not to be a preening pose, and
mapping the calculated ratio on a second health status scale, thereby obtaining a second health status value for the flock of birds.

9. The method of claim 8, further comprising:
selecting the second health status scale from a plurality of health status scales, each of which is representative of a respective type or species of birds.

10. The method of claim 8, wherein the second health status scale comprises two status values representing healthy and non-healthy, respectively, and wherein the step of mapping comprises:
mapping the calculated ratio on the first health status scale and thereby obtaining a status value representing non-healthy if the calculated ratio is between 0 and a threshold value and obtaining a status value representing healthy if the calculated ratio is between the threshold value and 1.

11. The method of claim 8, further comprising:
combining the first health status value and the second health status value to obtain a third health status value by:
calculating an average between the first health status value and the second health status value or calculating a sum of the first health status value and the second health status value, and
mapping the third health status value on a third health status scale that comprises two status values representing healthy and non-healthy and thereby obtaining a status value representing non-healthy if the third health status value is between 0 and a threshold value and obtaining a status value representing healthy if the third health status value is between the threshold value and 1.

12. A system comprising an illumination unit, an imaging unit and a control unit the control unit being configured to:
record a plurality of images of an area,
identify, in each image of the plurality of images, a respective image sub-region within which the flock of birds is present,
identify, in each image sub-region, at least one feather image region within which feathers are present,
determine, for each feather image region a respective reflectance value sample,
calculate an average reflectance value based on the reflectance value samples, and
map the average reflectance value on a first health status scale, thereby obtaining a first health status value for the flock of birds.

13. The system according to claim 12, wherein the control unit is configured to control the illumination unit to emit light comprising a lighting characteristic during a first period in time, wherein the lighting characteristic is configured to cause reflectance on feathers of the flock of birds, wherein the control unit is configured to record the plurality of images of the area within the first period in time.

14. The system according to claim 12, any wherein the lighting characteristic is a light spectrum, a light intensity, and/or a light polarity.

15. The system according to claim 13, wherein the illumination unit comprises the imaging unit.
